(19) United States
(12) Patent Application Publication
(10) Pub. No.: US 2022/0177158 A1
(43) Pub. Date: Jun. 9, 2022

(54) MANAGEMENT SYSTEM AND METHODS OF HANDLING BAGGAGE IN AIRPORT

(71) Applicant: Dong Keun Park, Michuhol-Gu (KR)

(72) Inventors: Dong Keun Park, Michuhol-Gu (KR); Jae Won Jeong, Seoul (KR); Seong Keun Park, Michuhol-Gu (KR); Seok Chan Kang, Anyang-Si (KR)

(21) Appl. No.: 17/643,550

(22) Filed: Dec. 9, 2021

(30) Foreign Application Priority Data
Dec. 9, 2020 (KR) 10-2020-0171696

(51) Int. Cl. B64F 1/36; G06Q 10/08

(52) U.S. Cl. CPC B64F 1/368; G06Q 10/0833; B64F 1/366

(57) ABSTRACT

Provided are a system and method for managing airport baggage. The system includes an electronic tag attached to baggage of each passenger and storing baggage information, a plurality of readers installed on one side of a conveyor, which automatically conveys the baggage to a gate and configured to recognize the electronic tag attached to the baggage passing therethrough, and an airport management server installed at each airport and configured to generate, when baggage check-in information is input, a baggage data table of a corresponding passenger and record, when baggage recognition information including reader identification information and baggage identification information is received from the reader, normal baggage recognition in a baggage data table corresponding to the baggage recognition information.

### CROSS-REFERENCE TO RELATED APPLICATION

This application claims priority to and the benefit of Korean Patent Application No. 10-2020-0171696, filed on Dec. 9, 2020, the disclosure of which is incorporated herein by reference in its entirety.

### BACKGROUND

### 1. Field of the Invention

The present invention relates to a system and method for managing airport baggage, and more particularly, to a system and method for managing airport baggage which rapidly check whether there is baggage trouble, such as lost baggage, and easily track the baggage involved in the trouble.

### 2. Discussion of Related Art

Airplanes are one of the means of transportation, and the use of airplanes is increasing day by day.

When a user uses an airplane, baggage over a certain capacity cannot be brought into the airplane, and thus a certain amount of items or specific items should be transported as cargo.

Baggage transported as described above is mixed with other users' baggage, and there is a risk of being lost. Users are anxious about this.

For this reason, various technologies are under development to manage baggage at airports.

However, according to the related art, only a baggage movement route is managed within the airport. When baggage is misdelivered to another airport, the user cannot know the information, and it is not possible to relieve the anxiety of losing baggage.

The related art of the present invention is disclosed in Korean Patent No. 10-0793419, Korean Unexamined Patent Application Publication No. 10-2009-0125448, and Korean Utility Model No. 20-0259840.

### SUMMARY OF THE INVENTION

The present invention is directed to providing a system and method for managing airport baggage which rapidly check whether there is baggage trouble, such as delayed baggage and lost baggage, and easily track the baggage involved in the trouble.

The present invention is directed to providing a system and method for managing airport baggage which detect the distance of baggage to the destination and the speed of a conveyor belt in a process of handling the baggage and notify a user of the estimated arrival time of the baggage or the time required for the arrival of the baggage through a text message, a web-based text message, and a social network service (SNS) such that the user's anxiety about information on the baggage and anxiety of losing the baggage.

Objects of the present invention are not limited to those described above, and other objects which have not described above will be clearly understood by those of ordinary skill in the art from the following descriptions.

According to an aspect of the present invention, there is provided a system for managing airport baggage, the system including an electronic tag attached to baggage of each passenger and storing baggage information, a plurality of readers installed on one side of a conveyor, which automatically conveys the baggage to a gate and configured to recognize the electronic tag attached to the baggage passing therethrough, and an airport management server installed at each airport and configured to generate, when baggage check-in information is input, a baggage data table of a corresponding passenger and record, when baggage recognition information including reader identification information and baggage identification information is received from the reader, normal baggage recognition in a baggage data table corresponding to the baggage recognition information.

The airport management server may generate a baggage data table with identification information of the readers provided in a baggage handling system, which will handle the baggage from a departure airport of the passenger to a destination airport, as a first axis and the baggage identification information of the passenger as a second axis.

When the baggage recognition information is received, the airport management server may record normal baggage recognition in a field corresponding to the reader identification information of the baggage data table corresponding to the baggage recognition information and may record no baggage recognition in a field corresponding to identification information of the reader from which the baggage recognition information is not received.

When the baggage is recognized normally by a certain number of consecutive readers, the airport management server may delete a baggage recognition record of the reader in front of the certain number of readers among baggage recognition records recorded in the baggage data table.

When the baggage is not recognized by a reader among the readers of the corresponding airport, the airport management server may track the baggage using the baggage data table.

When the baggage is not loaded onto a corresponding airplane on time or is not found, the airport management server may transmit baggage delay notice information to a terminal of the passenger.

The system may further include a baggage management server connected to the airport management server installed at each airport through a communication network and configured to transmit baggage misdelivery notice information including wrong airport (to where baggage is misdelivered) identification information to a terminal of the passenger when baggage misdelivery information is received from the airport management server, and when the baggage does not arrive at a destination, the airport management server may transmit the baggage misdelivery information including the airport identification information and the baggage information to the baggage management server.

The airport management server or the baggage management server may provide baggage handling situation information of at least one of check-in, transfer, and arrival of the baggage at the corresponding airport to the passenger and may search for, when the baggage is misdelivered, a fastest flight from the airport to the destination or a delivery address set by the passenger and transmit delivery schedule information of the misdelivered baggage including a retrieved flight and a scheduled arrival time of the flight to the terminal of the passenger.

According to another aspect of the present invention, there is provided a method of managing airport baggage, the method including, when baggage check-in information is input, generating, by an airport management server, a baggage data table of a corresponding passenger and, when baggage recognition information including reader identification information and baggage identification information is received from a reader, recording, by the airport management server, normal baggage recognition in the baggage data table corresponding to the baggage recognition information.

The method may further include determining, by the airport management server, whether the baggage has arrived at a destination through the baggage recognition information, when the baggage has not arrived at the destination, transmitting, by the airport management server, baggage misdelivery notice information including wrong airport (to where baggage is misdelivered) identification information to a terminal of the corresponding passenger and transmitting baggage misdelivery information including the airport identification information and baggage information to a baggage management server, and transmitting, by the baggage management server, information on a situation of handling the baggage to the terminal of the passenger.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram illustrating a system for managing airport baggage according to an exemplary embodiment of the present invention;

FIG. 2 is a diagram illustrating an example of a baggage information screen transmitted by the system for managing airport baggage according to the exemplary embodiment of the present invention;

FIG. 3 is a diagram illustrating a system for managing airport baggage according to another exemplary embodiment of the present invention;

FIG. 4 is an exemplary diagram illustrating a barcode attached to baggage according to the exemplary embodiment of the present invention;

FIG. 5 is an exemplary diagram illustrating a baggage data table according to the exemplary embodiment of the present invention;

FIG. 6 is an exemplary diagram illustrating a method of registering whether or not baggage has been recognized in a baggage data table according to the exemplary embodiment of the present invention;

FIG. 7 is an exemplary diagram illustrating information indicating that baggage has been handled normally at a departure airport according to the exemplary embodiment of the present invention;

FIG. 8 is an exemplary diagram illustrating a method of tracking baggage using a baggage data table according to the exemplary embodiment of the present invention;

FIG. 9 is an exemplary diagram illustrating information indicating that baggage has been handled normally at a transfer airport according to the exemplary embodiment of the present invention;

FIG. 10 is an exemplary diagram illustrating information indicating that baggage has not arrived at a transfer airport according to the exemplary embodiment of the present invention;

FIG. 11 is an exemplary diagram illustrating information indicating that baggage has not been handled normally at a transfer airport according to the exemplary embodiment of the present invention;

FIG. 12 is a block diagram illustrating an airport management server according to the exemplary embodiment of the present invention; FIG. 13 is a block diagram illustrating a baggage management server according to the exemplary embodiment of the present invention; and

FIG. 14 is a flowchart illustrating a method of managing airport baggage according to the exemplary embodiment of the present invention.

### DETAILED DESCRIPTION OF EXEMPLARY EMBODIMENTS

Hereinafter, a system and method for managing airport baggage according to exemplary embodiments of the present invention will be described with reference to the accompanying drawings. In this process, thicknesses of lines, sizes of elements, etc. shown in the drawings may be exaggerated for clarity and convenience of description.

Further, terms used below are defined in consideration of functionality in the present invention and may vary depending on the intentions or customs of a user or an operator. Therefore, definitions thereof should be made on the basis of the overall content of this specification.

Also, embodiments described herein may be implemented using, for example, a method or process, an apparatus, a software program, a data stream, or a signal. Even when discussed in the context of a single form of implementation (e.g., discussed only as a method), the implementation of discussed features may also be implemented in other forms (e.g., an apparatus or program). An apparatus may be implemented as appropriate hardware, software, firmware, etc. The method may be implemented in, for example, a device, such as a processor, which generally refers to a processing device including a computer, a microprocessor, an integrated circuit, or a programmable logic device. Processors also include communication devices, such as a computer, a cellular phone, a portable/personal digital assistant (PDA) 40, and other devices that facilitate communication of information between end users.

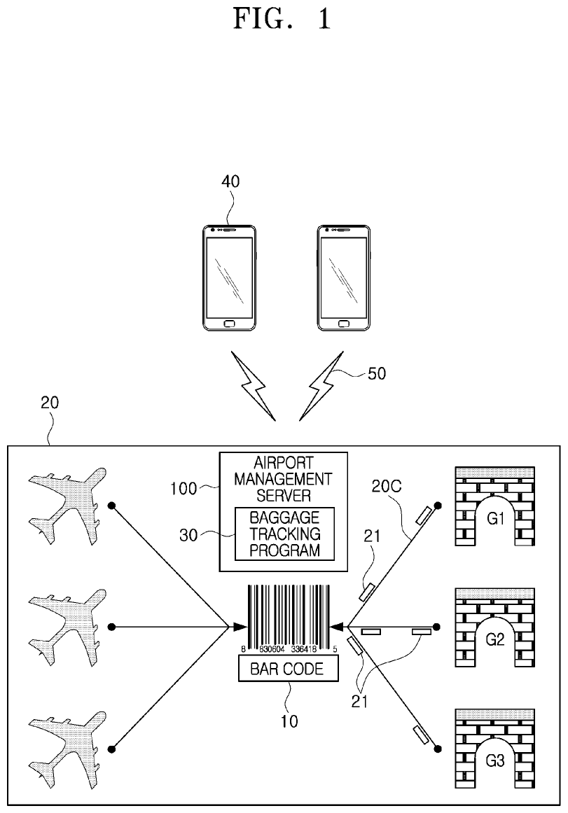

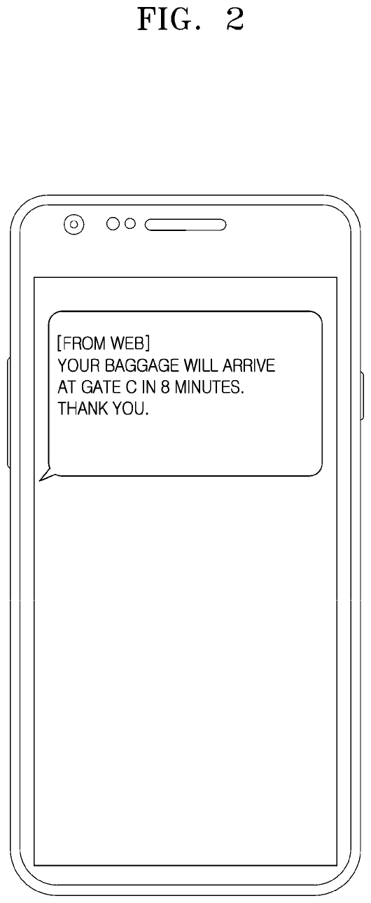

FIG. 1 is a diagram illustrating a system for managing airport baggage according to an exemplary embodiment of the present invention, and FIG. 2 is a diagram illustrating an example of a baggage information screen transmitted by the system for managing airport baggage according to the exemplary embodiment of the present invention.

Referring to FIG. 1, the system for managing airport baggage according to the exemplary embodiment of the present invention is connected to an automatic baggage handling system 20 including a plurality of conveyors 20c, which automatically convey baggage to gates, and includes a barcode 10 attached to the baggage and storing information on the baggage, barcode readers 21 installed on one side of the conveyors 20c to recognize the barcode attached to the baggage passing therethrough, a baggage tracking program 30 for calculating the location of the baggage from the location of the barcode reader 21 installed at a location through which the baggage including the barcode 10 thereon passes and the operating speed of the conveyor 20c and transmitting information on the calculated location of the baggage to a terminal 40 of a passenger through a text message, a web-based text message, or a social network service (SNS), and the terminal 40 of the passenger for accessing the automatic baggage handling system 20 through a wireless communication network 50 and receiving the location information and arrival gate information of the baggage.

The automatic baggage handling system 20 is a system that is currently installed in an airport to automatically sort baggage unloaded from airplanes and deliver the sorted baggage to corresponding gates. The automatic baggage handling system 20 includes the conveyors 20c that automatically convey baggage and an apparatus for controlling the operation of the conveyors 20c and processing baggage information, that is, an airport management server 100. The airport management server 100 may be implemented as a computer that may access a server or terminal at a remote site through a communication network. For example, the computer may include a navigation device, a tablet personal computer (PC), a desktop computer, a laptop computer, etc. on which a web browser is installed.

The baggage tracking program 30 may be installed on the airport management server 100. When the baggage tracking program 30 is installed, the airport management server 100 may display a baggage tracking screen. A passenger who wants to use a baggage tracking service may apply for a baggage tracking service for preventing lost baggage through the baggage tracking screen.

As described above, the baggage tracking program 30 functions to collect and transmit baggage information to the terminal 40 of the passenger. Baggage tracking is performed by comparing baggage information input to the automatic baggage handling system 20 in advance and information detected by the barcode reader 21 and analyzing the comparison result.

As shown in FIG. 1, the plurality of barcode readers 21 may be installed on one side of the conveyors 20c. The barcode readers 21 are devices for collecting the movement information of baggage. In the case of a long conveyor 20c, a plurality of barcode readers 21 may be installed on one line. Preferably, a barcode reader 21 is installed at the entrance and exit of the corresponding conveyor 20c.

In other words, a barcode reader 21 is installed at the entrance of a conveyor 20c on which baggage is unloaded from an airplane and the end of the conveyor 20c, and thus the baggage tracking program 30 preferably enables the passenger to be aware of which conveyor 20c the corresponding baggage is loaded on and the number of a gate to which the baggage will be output.

The conveyors 20c may be connected to each other such that the baggage may move to another place. Accordingly, the barcode reader 21 may also be installed at a junction. When the baggage moves to another conveyer, this information may be detected by the baggage tracking program 30 and transmitted to the automatic baggage handling system 20 such that the movement route of the baggage may be changed.

To accurately calculate movement information of the baggage and information on the output to a gate, the baggage tracking program 30 may track the location of the baggage from the time when the baggage is loaded on the conveyor 20c and the speed of the conveyor 20c.

A method of managing baggage using the system for managing airport baggage configured as described above will be described below.

First, to use an airport baggage management service of the present invention, a user may apply for the airport baggage management service using his or her own terminal 40. In this case, the user terminal 40 may execute and display an airport baggage management service program (or application) or an airport baggage management service website provided by the airport management server 100, and the user may apply for the airport baggage management service through the airport baggage management service program (or application) or the airport baggage management service website.

To use the service, that is, to use an airport, the user may apply for the airport baggage management service that the user subscribes to. When the service request is made, the baggage tracking program 30 may compare user information and baggage information sent by the user and transmit the baggage information of the user to the terminal 40 of the user to confirm whether the user information corresponds to the baggage information. When it is confirmed that the user information corresponds to the baggage information, location information of the baggage may be transmitted to the user afterward.

In this case, the baggage information may be transmitted to the user as a text message at a point in time when the barcode 10 is scanned, at set regular time intervals, or in real time when the user wants the baggage information. For example, the baggage information may be transmitted to the user as soon as the barcode 10 is recognized, at time intervals set in the system, and when requested by the user.

The baggage information may be information calculated by the baggage tracking program 30 using location information of the barcode reader 21 that has scanned the barcode 10 and the speed of the conveyor 20c.

In the system and method for managing airport baggage configured as described above according to the present invention, when baggage is sorted and moved to a destination by the automatic baggage handling system 20, the required time is calculated using a conveyor belt moving at regular speed and the distance to a gate and transmitted to a service user as a text message in real time. For example, the automatic baggage handling system 20 may transmit the text message “Your baggage will arrive at Gate 6 in 9 minutes” as shown in FIG. 2. The service user who receives the text message may be aware of when (time) and where (location) his or her baggage will be delivered in advance, which may reduce anxiety about lost baggage. In this way, according to the present invention, baggage information is transmitted to a user in real time such that the user can drop off his or her baggage with confidence.

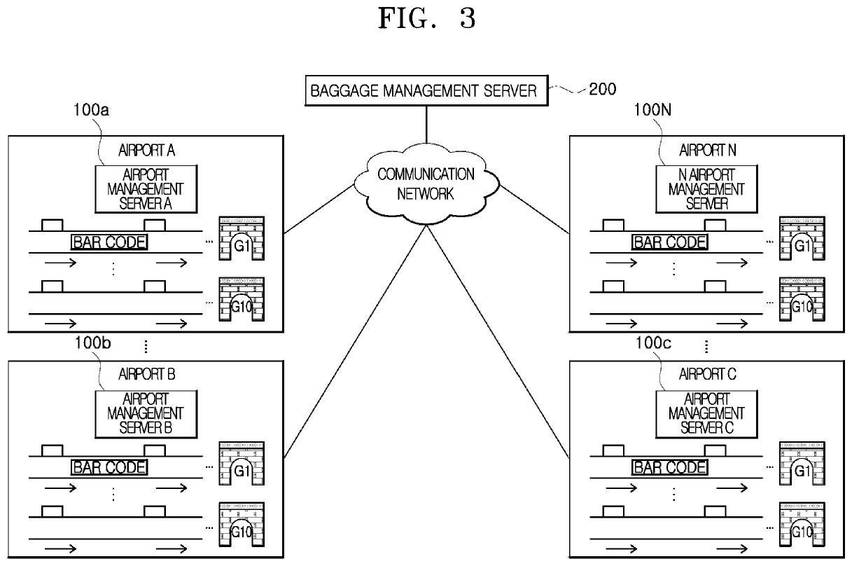

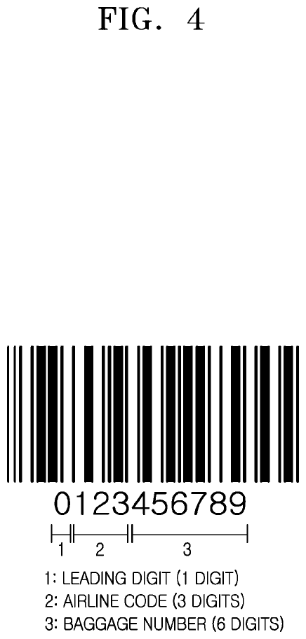

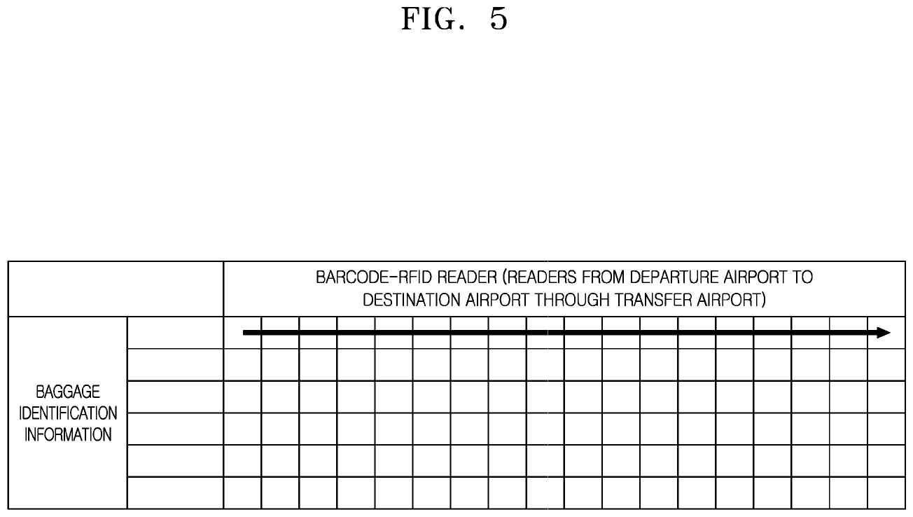

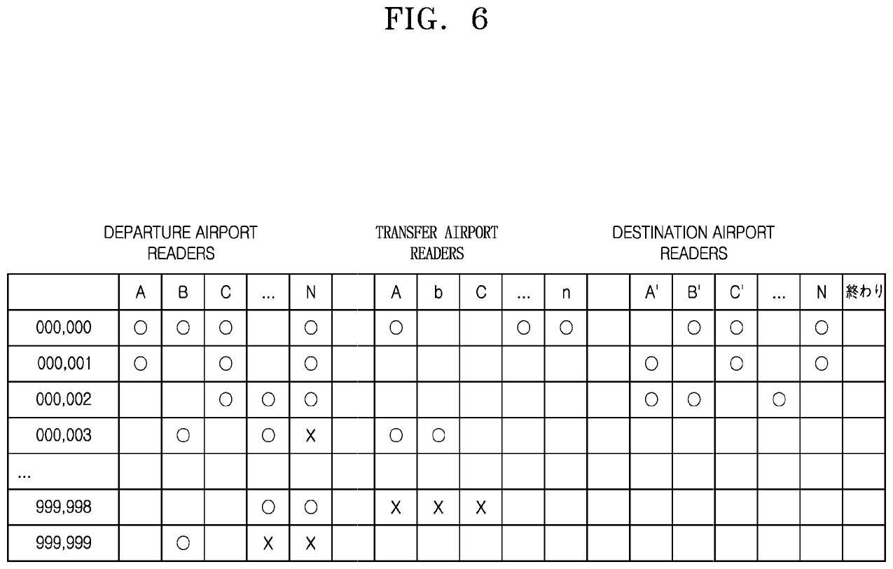

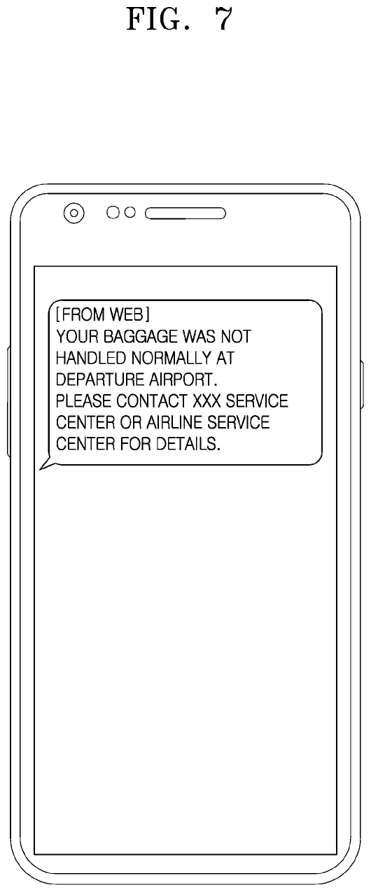

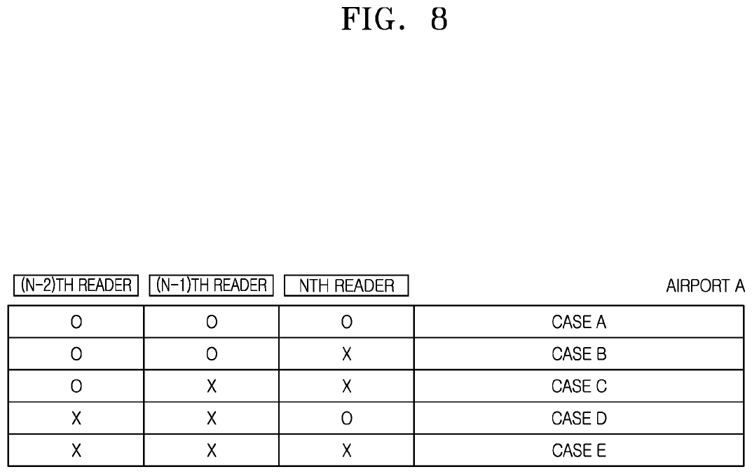

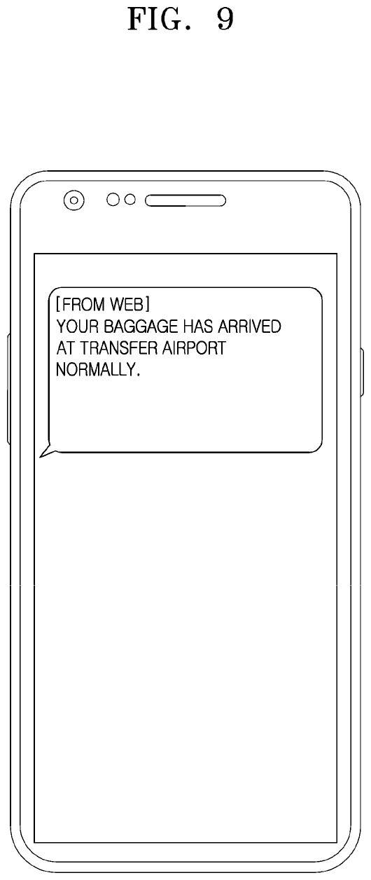

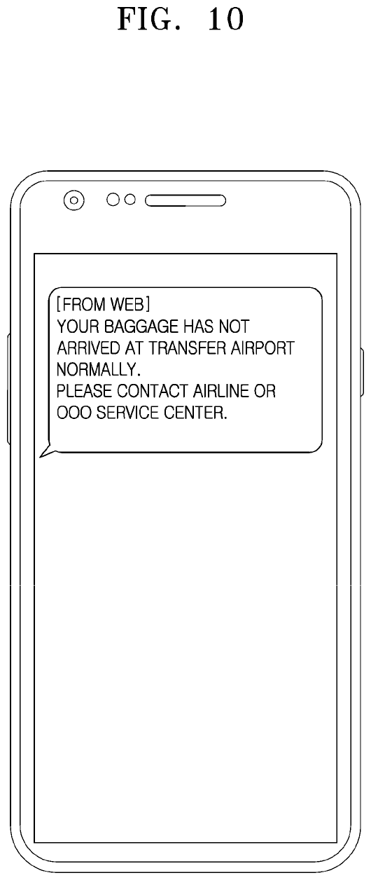

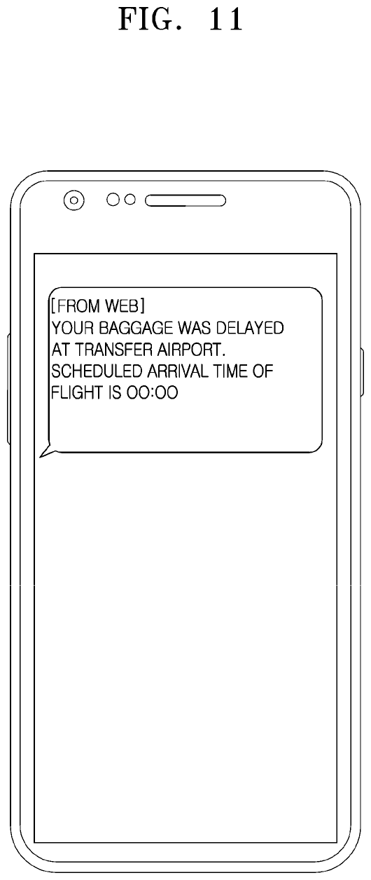

FIG. 3 is a diagram illustrating a system for managing airport baggage according to another exemplary embodiment of the present invention. FIG. 4 is an exemplary diagram illustrating a barcode attached to baggage according to the exemplary embodiment of the present invention. FIG. 5 is an exemplary diagram illustrating a baggage data table according to the exemplary embodiment of the present invention. FIG. 6 is an exemplary diagram illustrating a method of registering whether or not baggage has been recognized in a baggage data table according to the exemplary embodiment of the present invention. FIG. 7 is an exemplary diagram illustrating information indicating that baggage has been handled normally at a departure airport according to the exemplary embodiment of the present invention. FIG. 8 is an exemplary diagram illustrating a method of tracking baggage using a baggage data table according to the exemplary embodiment of the present invention. FIG. 9 is an exemplary diagram illustrating information indicating that baggage has been handled normally at a transfer airport according to the exemplary embodiment of the present invention. FIG. 10 is an exemplary diagram illustrating information indicating that baggage has not arrived at a transfer airport according to the exemplary embodiment of the present invention. FIG. 11 is an exemplary diagram illustrating information indicating that baggage has not been handled normally at a transfer airport according to the exemplary embodiment of the present invention.

Referring to FIG. 3, the system for managing airport baggage according to another exemplary embodiment of the present invention may include an electronic tag 10, readers 21 that are installed on one side of conveyors 20c to recognize electronic tags attached to baggage passing therethrough, airport management servers 100a, 100b, . . . , and 100n (hereinafter 100), and a baggage management server 200. The electronic tag 10, the readers 21, and the airport management server 100 are installed at each airport, and the baggage management server 200 may manage the airport management server 100 installed at each airport.

The electronic tag 10 is attached to the baggage of passengers. In the electronic tag 10, baggage information including one or more of passenger identification information, baggage identification information, an origin, a destination, flight information (departure and transfer), a departure time, an arrival time, and contents. The electronic tag 10 may include a barcode, a radio frequency identification (RFID) tag, etc., but for convenience of description, the following description will be limited to a barcode.

The plurality of readers 21 are installed at certain distances along the conveyors 20c on which the baggage of passengers moves. In general, the baggage of passengers is moved through the conveyors 20c in airports, and thus the readers 21 are installed at the certain distances to locate baggage in real time.

The readers 21 are installed on one side of the conveyors 20c that automatically convey baggage to gates. The readers 21 recognize the barcode 10 attached to baggage passing therethrough, read baggage information, and then transmit baggage recognition information to the airport management server 100. Here, the baggage recognition information may include reader identification information and baggage information. The reader identification information may be a unique identifier (ID) in a baggage database 126, and the baggage information may include baggage (unique) identification information.

For example, a barcode attached to baggage may be as shown in FIG. 4. Referring to FIG. 4, an airport baggage barcode may have 10 digits. The first digit (leading digit) may represent a baggage type, the subsequent three digits may represent an airline code, and the last six digits may represent a baggage identification number. When a barcode attached to baggage is recognized, the baggage database 126 may transmit reader identification information and baggage identification information to the airport management server 100.

When check-in information of a passenger and baggage check-in information are input, the airport management server 100 may generate a baggage data table of the corresponding passenger. In this case, the airport management server 100 may generate the baggage data table with identification information of the readers 21 provided in a baggage handling system, which will handle the baggage from a departure airport of the passenger to a destination airport, as a first axis and baggage identification information of the passenger as a second axis. In other words, the airport management server 100 may generate the baggage data table with identification information of readers 21 provided in a baggage handling system, which will handle the baggage at the departure airport, identification information of readers 21 provided in a baggage handling system, which will handle the baggage at the transfer airport, and identification information of readers 21 provided in a baggage handling system, which will handle the baggage at the destination airport, as the first axis and the baggage identification information of the passenger as the second axis. For example, the airport management server 100 may generate a baggage data table as shown in FIG. 5. Referring to FIG. 5, baggage identification information (six digits: 000000 to 999999) may be recorded along the vertical axis of the baggage data table, and reader identification information of airports (from the departure airport to the destination airport) used by the passenger may be recorded along the horizontal axis.

When baggage recognition information is received from the reader 21, the airport management server 100 may register the baggage recognition information in a baggage data table. In other words, when baggage recognition information including reader identification information and baggage identification information is received from the reader 21, the airport management server 100 may record normal baggage recognition in a baggage data table corresponding to the baggage identification information and the reader identification information. Specifically, when the baggage recognition information is received, the airport management server 100 may record normal baggage recognition in a field corresponding to the reader identification information in the baggage data table corresponding to the baggage identification information and record no baggage recognition in a field corresponding to the identification information of a reader from which the baggage recognition information has not been received.

For example, the airport management server 100 may record normal baggage recognition and no baggage recognition as shown in FIG. 6. Referring to FIG. 6, the airport management server 100 may record “0” in a corresponding field when the barcode of baggage is recognized by the reader 21 normally and may record “X” in the corresponding field when the baggage is not recognized by the reader 21.

When baggage recognition information is received from the reader 21, the airport management server 100 may analyze the baggage recognition information to check reader identification information and baggage identification information as described above. The airport management server 100 may display “0” or “X” in a field corresponding to the reader identification information in a baggage data table corresponding to the baggage identification information.

When a certain number of consecutive readers 21 recognize baggage normally, the airport management server 100 may delete baggage recognition records of a reader in front of the certain number of readers among baggage recognition records recorded in a baggage data table.

For example, when baggage is recognized normally three consecutive times (n-2, n-1, and n) in the recognition process of each reader, the airport management server 100 may delete the recognition record of a reader (up to the (n-3)^{th} reader) in front of the (n-2)^{th} reader. In other words, when readers A, B, and C succeed in recognizing baggage and then reader N succeeds in recognizing the baggage, the airport management server 100 may delete information of reader A and record only information of readers B, C, and N.

In this way, the airport management server 100 may efficiently manage reader-specific baggage recognition information using a baggage data table. Also, when baggage is not recognized by the reader 21, the airport management server 100 may record information that the baggage has not been recognized by the corresponding reader 21 in the baggage data table. Baggage trouble data can be acquired from such a baggage data table, and big data can be generated from baggage trouble data to track baggage involved in the trouble, which may lead to a system improvement through a scientific approach to trouble and application of artificial intelligence (AI).

When the baggage is recognized normally by all the readers 21 at the corresponding airport, the airport management server 100 may transmit a text message that the baggage has been handled normally to the terminal 40 of the passenger. For example, when the baggage is handled normally at airport A and arrives normally at the destination airport, the airport management server 100 may transmit a text message to the terminal 40 of the passenger as shown in FIG. 2.

When the baggage is not recognized normally by all the readers 21 at the corresponding airport, the airport management server 100 may track the baggage using the baggage data table. When the baggage is not loaded onto the corresponding airplane on time or is not found after being tracked, the airport management server 100 may transmit baggage delay notice information to the terminal 40 of the passenger. For example, the airport management server 100 may transmit the text message “Your baggage has not been handled normally at the departure airport” to the terminal 40 of the passenger as shown in FIG. 7.

A method in which the airport management server 100 tracks baggage A using a baggage data table will be described with reference to FIG. 8. Referring to FIG. 8, Case A represents a case in which all readers 21 recognize baggage A normally at airport A. In this case, since all the readers 21 have recognized baggage A normally, the airport management server 100 may determine that there is no baggage trouble at airport A and thus delete records of the baggage data table of baggage A at airport A.

Case B represents a case in which there is baggage recognition trouble at the n^{th} reader. In this case, since baggage A has not been recognized by the n^{th} reader at airport A, an administrator may track baggage A around the n^{th} reader at airport A. In this case, the administrator may check for baggage A falling off the conveyor, tag loss, staff mistakes, etc. When baggage A is found in airport A and normally loaded onto a corresponding airplane on time, the airport management server 100 may delete records about baggage A in the baggage data table at airport A. When baggage A is found in airport A but is not loaded onto the corresponding airplane on time or baggage A is not found, the airport management server 100 may transmit baggage delay notice information to the terminal 40 of the passenger and track baggage A in the section from the n^{th} reader to the (n-1)^{th} reader.

Case C represents a case in which there are two instances of baggage recognition trouble at the (n-1)^{th} reader and the n^{th} reader. In this case, since baggage A has not been recognized by the (n-1)^{th} reader and the n^{th} reader at airport A, the administrator may track baggage A around the (n-1)^{th} reader and the n^{th} reader at airport A. In this case, the administrator may check for baggage A falling off the conveyor, tag loss, staff mistakes, etc. When baggage A is found in airport A and normally loaded onto the corresponding airplane on time, the airport management server 100 may delete records about baggage A in the baggage data table at airport A. When baggage A is found in airport A but is not loaded onto the corresponding airplane on time or baggage A is not found, the airport management server 100 may transmit baggage delay notice information to the terminal 40 of the passenger and track baggage A in the section from the (n-2)^{th} reader to the (n-1)^{th} reader.

Case D represents a case in which there are two instances of baggage recognition trouble at the (n-2)^{th} reader and the (n-1)^{th} reader. In this case, since baggage A has not been recognized by the (n-2)^{th} reader and the (n-1)^{th} reader at airport A, the administrator may track baggage A around the (n-2)^{th} reader and the (n-1)^{th} reader at airport A. In this case, the administrator may check for baggage A falling off the conveyor, tag loss, staff mistakes, etc. When baggage A is found in airport A and normally loaded onto the corresponding airplane on time, the airport management server 100 may delete records about baggage A in the baggage data table at airport A. When baggage A is found in airport Abut is not loaded onto the corresponding airplane on time or baggage A is not found, the airport management server 100 may transmit baggage delay notice information to the terminal 40 of the passenger and track baggage A in the section from the (n-3)^{th} reader to the (n-2)^{th} reader.

Case E represents a case in which there is baggage recognition trouble. In this case, since baggage A has not been recognized by the (n-2)^{th} reader, the (n-1)^{th} reader, and the n^{th} reader at airport A, the administrator may track baggage A around the (n-4)^{th} reader, the (n-3)^{th} reader, etc. at airport A. In this case, the administrator may check for baggage A falling off the conveyor, tag loss, staff mistakes, etc. When baggage A is found in airport A and normally loaded onto the corresponding airplane on time, the airport management server 100 may delete records about baggage A in the baggage data table at airport A. When baggage A is found in airport A but is not loaded onto the corresponding airplane on time or baggage A is not found, the airport management server 100 may transmit baggage delay notice information to the terminal 40 of the passenger and track baggage A in the section from the (n-5)^{th} reader to the (n-3)^{th} reader.

When the baggage arrives at the destination, the airport management server 100 may calculate baggage location information from reader identification information and the operating speed of the conveyor and transmit the baggage location information to the terminal 40 of the passenger. On the other hand, when the baggage has not arrived at the destination, the airport management server 100 may transmit baggage misdelivery information including airport identification information and the baggage information to the baggage management server 200.

Specifically, when the baggage recognition information is received, the airport management server 100 recognizes the destination through the baggage information and determines whether the recognized destination corresponds to the current airport. When it is determined that the destination corresponds to the current airport, the airport management server 100 may determine that the baggage has arrived at the destination. On the other hand, when the destination does not correspond to the current airport, the airport management server 100 may determine that the baggage has been misdelivered to an airport that is not the destination.

Meanwhile, baggage retrieval may be delayed in some cases such as where the baggage arrives at the destination airport later than the passenger because there has been baggage handling trouble at the departure airport or where a standby time increases because baggage handling is delayed at the destination airport. In this case, the airport is required to notify the passenger that the baggage is delayed and why.

Therefore, the airport management server 100 may determine whether baggage retrieval is delayed using the baggage data table. When it is recorded in the baggage data table that all the readers 21 at the corresponding airport have normally recognized the baggage, the airport management server 100 calculates baggage location information from reader identification information and the conveyor operating speed and transmits the baggage location information to the terminal 40 of the passenger. In other words, the airport management server 100 may locate the corresponding reader 21 through the reader identification information and locate the baggage through the location of the corresponding reader 21. Also, the airport management server 100 may identify the passenger who is the owner of the baggage through the baggage information and transmit the baggage location information to the passenger through the identification. In this case, the airport management server 100 may transmit a text message to the passenger as shown in FIG. 2 to notify the passenger that the baggage has normally arrived.

In addition, the airport management server 100 may determine whether the baggage is moving along a correct route. The airport management server 100 may generate and then transmit baggage location information, which includes the location of the baggage, the time at the corresponding location, an estimated arrival time (an estimated arrival time at a gate where the passenger waits), etc., to the terminal 40 of the passenger. In this case, the airport management server 100 may transmit the baggage location information in real time or periodically at certain time intervals.

When the baggage is not loaded onto the airplane on time at the corresponding airport or is not found, the airport management server 100 may transmit baggage delay notice information to the terminal 40 of the passenger, detect the reader section in which the baggage has not been recognized in the baggage data table, and track the baggage in the detected reader section.

For example, the baggage may be delayed when a problem occurs at the departure airport during baggage transportation (falling off the conveyor belt or the like), the baggage is not loaded at the departure airport (a mistake or when the baggage is transported by the next airplane due to a lack of cargo space in the airplane), baggage handling is delayed for the airplane with the passenger after arrival at the destination airport because there is a great deal of baggage waiting or a problem occurs, a trouble, such as the baggage's falling off the conveyor belt or non-recognition of the baggage, is caused after arrival at the destination airport, etc. When the baggage is delayed because a problem occurs at the departure airport during baggage transportation or the baggage is not loaded at the departure airport, the passenger often finds out the cause of a problem before arriving at the destination airport. When being aware of the fact that the baggage is delayed and why, the airport management server 100 may transmit baggage delay notice information to the passenger as a text message to let the passenger know the fact and the reason upon arrival at the destination airport or may send the notification through an application, a homepage, etc. to enable the passenger to check the notification. Also, when the waiting time lengthens because baggage handling is delayed though the baggage has arrived at the destination airport together with the passenger, the airport management server 100 may send the corresponding reason or the fact that the baggage handling is delayed to the passenger as a text message in real time or send the notification through the application or homepage in real time to enable the passenger to check the notification.

As described above, when the baggage is moving away from a destination route in an airport (e.g., a route to a gate where the passenger waits in the case of the destination airport or a route to an airplane used by the passenger in the case of the departure airport), the airport management server 100 may transmit a message indicating that the baggage has deviated from the destination route in the airport to the terminal 40 of the passenger. In this case, the passenger may immediately take action to prevent his or her baggage from being lost or stolen.

For example, the airport management server 100 of the departure airport may locate the baggage in real time using the baggage data table and send a warning message to the administrator or transmit a warning message to the terminal 40 of the passenger when the baggage is not moved toward the airplane used by the passenger. Also, the airport management server 100 of the destination airport may locate the baggage in real time and send a warning message to the administrator or transmit a warning message to the terminal 40 of the passenger when the baggage deviates from the conveyor belt or is not moved toward a gate where the passenger waits.

Next, when the baggage does not arrive at the destination, the airport management server 100 may transmit misdelivery information including the airport identification information and the baggage information to the baggage management server 200. In this case, the airport management server 100 may transmit baggage misdelivery notice information to the terminal 40 of the passenger.

The baggage may be incorrectly delivered to an airport other than the destination airport, and the destination airport may include a transfer airport or an arrival airport. In this case, an airport network is needed to manage the baggage incorrectly delivered to another airport. Accordingly, the system according to the present invention includes the baggage management server 200 that is connected to each airport management server 100 and transmits baggage misdelivery notice information to the owner of misdelivered baggage.

Meanwhile, the misdelivered baggage may arrive at the wrong airport before or after the corresponding passenger arrives at the destination airport.

When the baggage arrives at the wrong airport before the passenger arrives at the destination airport, the airport management server 100 finds out that the baggage has been incorrectly delivered by referring to the baggage data table. The airport management server 100 transmits baggage misdelivery information to the baggage management server 200 for sharing and delivers baggage misdelivery notice information to the passenger as a text message or sends a notification linked to the application or homepage to enable the passenger to check the notification. In this way, the passenger can find out that his or her baggage has been misdelivered as soon as arriving at the destination airport. Accordingly, the misdelivered baggage can be rapidly and correctly handled, and it is possible to reduce the risk of losing the baggage.

Next, when the baggage arrives at the wrong airport after the passenger arrives at the destination airport and the airport management server 100 does not notify the passenger that the baggage has been incorrectly delivered, the passenger continues to wait at the airport where the baggage is not delivered and report the loss to the airline. To prevent such a situation, the airport management server 100 of the destination airport transmits baggage misdelivery notice information to the terminal 40 of the passenger and transmits baggage tracking request information to the baggage management server 200. The baggage tracking request information may include the passenger identification information, the baggage identification information, etc.

As described above, when the baggage arrives normally at the destination airport but falls off the conveyor belt or is not recognized, the airport management server 100 may transmit baggage delay notice information indicating that the baggage has not been handled normally to the terminal 40 of the passenger. When the corresponding problem is not resolved and the baggage is delayed, the airport management server 100 may transmit notice information indicating that the problem has not been resolved yet to the terminal 40 of passenger, and when the problem is normally resolved, the airport management server 100 may transmit notice information indicating that the problem has been resolved to the terminal 40 of the passenger.

Also, when the baggage arrives at the wrong airport and the barcode 10 of the baggage is recognized, the airport management server 100 may send wrong airport information (the airport the baggage has arrived at) to the passenger as a text message or send a notification through the application or homepage to enable the passenger to check the notification. In addition, when the baggage is misdelivered, the airport management server 100 provides a service for connecting to a baggage management service center or an airline service center. In this way, after arriving at the destination airport, the passenger can find out that the baggage is lost before reporting loss of the baggage, and the reporting process can be facilitated. Also, when the baggage arrives at the wrong airport, misdelivery information can be immediately acquired, and thus it is possible to increase efficiency in baggage handling time.

Further, the airport management server 100 is required to deliver the misdelivered baggage to the passenger. Accordingly, the airport management server 100 may search for the fastest flight that goes from the wrong airport to the destination (destination airport) or a delivery address set by the passenger and transmit delivery schedule information of the misdelivered baggage including a retrieved flight and a scheduled arrival time of the flight to the terminal 40 of the passenger. The scheduled arrival time of the retrieved flight may be later or earlier than the scheduled time of the passenger's arrival at the destination. When the scheduled arrival time of the retrieved flight is later than the scheduled time of the passenger's arrival at the destination, the airport management server 100 may include a delivery address change menu in delivery schedule information of the misdelivered baggage and transmit the delivery schedule information of the misdelivered baggage to the terminal 40 of the passenger. The passenger who receives the delivery schedule information of the misdelivered baggage may change an airport (delivery address) to which the misdelivered baggage will be delivered through the delivery address change menu.

For example, when the passenger departing from a first airport goes to a third airport via a second airport, his or her baggage may be misdelivered from the first airport to a fourth airport. In this case, the airport management server of the fourth airport may search for a flight going from the fourth airport to the second airport and transmit delivery schedule information of the misdelivered baggage including a retrieved flight, a scheduled arrival time of the flight, and the delivery address change menu to the terminal 40 of the passenger. The passenger may change the delivery address to the third airport through the delivery address change menu.

When information for changing the delivery address is received from the terminal 40 of the passenger, the airport management server 100 may transmit delivery notice information of the misdelivered baggage including the fastest flight going to the changed delivery address and a scheduled arrival time of the flight to the terminal 40 of the passenger.

The terminal 40 of the passenger receives baggage location information, baggage delay notice information, baggage misdelivery notice information, etc. from the airport management server 100 or the baggage management server 200 and outputs the received information. In this case, the passenger can check the location of the baggage in real time (or periodically) and can confirm the scheduled arrival time of his or her baggage and do something else in the meantime. In addition, the passenger can confirm that his or her baggage has been delivered to another airport through the baggage misdelivery notice information and rapidly take action accordingly such that the baggage can be prevented from being lost or stolen.

The terminal 40 of the passenger may be any device, such as a mobile communication terminal, a personal portable terminal, and a personal computer, that may access an airport baggage management system through a communication network to receive baggage information and user information or may receive distribution information in the form of a short text message or email from the airport management server 100 or the baggage management server 200.

The baggage management server 200 may be connected to the airport management server 100 installed at each airport through a communication network. When baggage misdelivery information is received from the airport management server 100, the baggage management server 200 may transmit baggage misdelivery notice information including information on the wrong airport (to where baggage is misdelivered) to the terminal 40 of the passenger.

Also, when baggage tracking request information is received from the airport management server 100, the baggage management server 200 may transmit information on the situation of handling the corresponding baggage to the terminal 40 of the passenger. In other words, the baggage management server 200 may track the misdelivered baggage and transmit notice information related to the baggage to the terminal 40 of the passenger. Specifically, after transmitting the baggage misdelivery notice information, the baggage management server 200 may transmit baggage handling situation information to the passenger at preset regular time intervals (e.g., 10 minutes to 30 minutes) to continuously notify the user of the baggage handling process. In this case, the baggage management server 200 may transmit the baggage handling situation information through a text message, a web-based text message, a voice message, email, an SNS, etc. In this way, the passenger can be continuously aware of the situation of searching for the baggage. The baggage handling situation information may be rejected when not wanted by the passenger.

The baggage management server 200 is required to have the misdelivered baggage delivered to the passenger. Accordingly, the baggage management server 200 may search for the fastest flight going from the wrong airport to the destination (destination airport) or the delivery address set by the passenger and transmit delivery schedule information of the misdelivered baggage including a retrieved flight and scheduled arrival time of the flight to the terminal 40 of the passenger. Here, when the scheduled arrival time of the retrieved flight is later than the scheduled time of the passenger's arrival at the destination, the baggage management server 200 may include the delivery address change menu in delivery schedule information of the misdelivered baggage and transmit the delivery schedule information of the misdelivered baggage to the terminal 40 of the passenger. The passenger who receives the delivery schedule information of the misdelivered baggage may change an airport (delivery address) to which the misdelivered baggage will be delivered through the delivery address change menu. When delivery address change information is received from the terminal 40 of the passenger, the baggage management server 200 may transmit delivery notice information of the misdelivered baggage including the fastest flight going to the changed delivery address and a scheduled arrival time of the flight to the terminal 40 of the passenger.

The airport management server 100 or the baggage management server 200 may provide comprehensive information of baggage check-in, transfer, and arrival processes performed at the airport. Providing the comprehensive information is a service for a passenger to check whether each of all baggage handling processes is performed normally. In this way, a process in which baggage is handled can be checked in detail, and when there is baggage trouble, it is possible to immediately find out in which section the problem has occurred. This may be basically based on a text message and may be provided in various ways, such as a baggage management application, the homepage, and an SNS.

Baggage handling processes may be classified into a total of three cases: the case of a direct flight, the case of a transfer airport where the baggage is automatically handled, and the case of a transfer airport where the passenger personally transfers the baggage.

First, the case of a direct flight will be described. In the case of a direct flight, the airport management server 100 or the baggage management server 200 may notify the passenger of (1) check-in (including early check-in) information, (2) whether the baggage has arrived and gate information, and (3) gate information and an arrival time. In process (3), when a process of an Xray, customs check, etc. is finished, the baggage may be compared with the airport management server 100 or an airport facility, such as an RFID reader, a barcode tag reader, or a camera, and checked in at least one way, and whether the baggage has been handled may be checked through the homepage or application.

Next, the case of a transfer airport where the baggage is automatically handled will be described. When the baggage is automatically transferred during a transfer, the airport management server 100 or the baggage management server 200 may notify the passenger of (1) check-in (including early check-in) information, (2) baggage handling at the transfer airport (checking the check-in of the transfer baggage), (3) whether the baggage has arrived and gate information, and (4) gate information and an arrival time. In process (2), when the baggage arrives at the transfer airport normally, the airport management server 100 may transmit a text message indicating that the baggage has arrived at the transfer airport normally to the passenger as shown in FIG. 9. When the baggage does not arrive at the transfer airport normally, the airport management server 100 may transmit a text message indicating that the baggage has not arrived at the transfer airport normally as shown in FIG. 10. Also, when departure of the baggage is delayed at the transfer airport, the airport management server 100 may transmit the text message “Departure was delayed at the transfer airport, and the scheduled arrival time of the flight is 00:00” to the terminal 40 of the passenger as shown in FIG. 11.

Finally, the case of a transfer airport where the passenger personally handles the baggage will be described. When the passenger personally retrieves the baggage and checks in the baggage again at the transfer airport, the airport management server 100 or the baggage management server 200 may notify the passenger of (1) check-in (including early check-in) information, (2) baggage handling at the transfer airport (checking the check-in of the transfer baggage), (3) transfer processing at the transfer airport, (4) whether the baggage has arrived and gate information, and (5) gate information and an arrival time. This is similar to automatic baggage handling at the transfer airport but additionally includes a process of retrieving and checking in the baggage again during a transfer. In other words, a process of providing a notification about “when and where the baggage comes out” and a notification about “when and where the baggage is to be checked in” is added. Accordingly, the airport management server 100 and the baggage management server 200 may transmit information about when and where to retrieve the baggage at the transfer airport and where to check in the baggage to the terminal 40 of the passenger and also through the application or the homepage. Due to this service, even when the passenger uses a connecting flight, he or she can use all services applied to a direct flight in the same way.

The above-described comprehensive information providing service may be received using a method of receiving handling processes in each section, a method of receiving a text message only in a section having a problem, a method of comprehensively checking handling processes of all the sections through the application and the homepage, etc. First, the method of receiving handling processes in each section may be a method of transmitting all processes of baggage handling as text messages.

When the passenger applies for the comprehensive information providing service, it is possible to select a language that he or she wants. The airport management server 100 and the baggage management server 200 may provide comprehensive information in a language, such as Korean, English, Chinese, Japanese, or another language, that is most convenient for the passenger.

The airport baggage management system can provide a high-quality service to passengers, rapidly determine whether baggage has arrived, and reduce waiting and handling time in the case of a baggage problem. Also, the airport baggage management system can reduce the risk of losing baggage and prevent lost baggage, and thus it is possible to build a comprehensively comfortable aviation lifestyle.

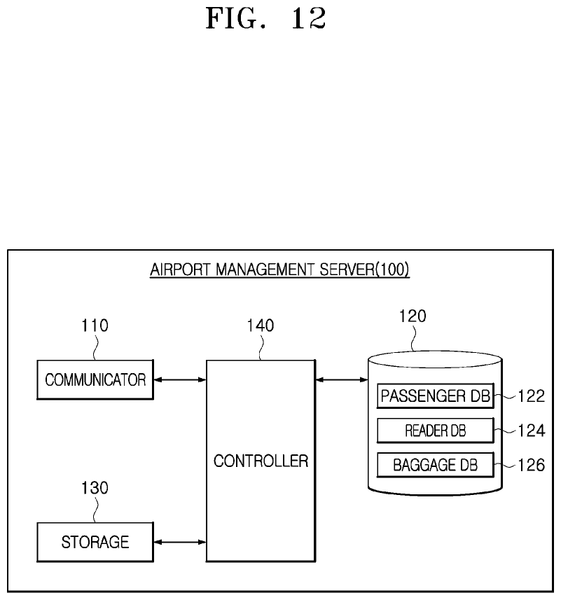

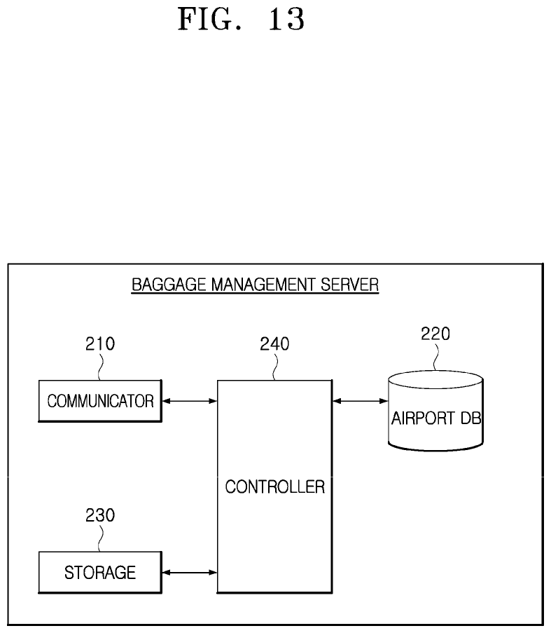

FIG. 12 is a block diagram illustrating an airport management server according to the exemplary embodiment of the present invention.

Referring to FIG. 12, the airport management server 100 according to the exemplary embodiment of the present invention includes a communicator 110, a database 120, a storage 130, and a controller 140.

The communicator 110 may communicate with the readers 21, the terminal 40 of the passenger, and the baggage management server 200 through a communication network.

The database 120 includes a passenger database 122, a reader database 124, and a baggage database 126. The passenger database 122 may store names, terminal numbers, origins, destinations, flights, whether there is baggage, contents, etc. according to passengers. The reader database 124 may store information on the location of each reader 21. The information stored in the passenger database 122 may be shared among airports. For example, the departure airport of a certain passenger transmits the passenger identification information of the passenger to the destination airport of the passenger to share passenger information.

In the baggage database 126, the baggage data table of each passenger may be stored. The baggage data table has been described above with reference to FIG. 5.

The storage 130 is a component for storing data related to operations of the airport management server 100. As the storage 130, a well-known storage medium may be used. For example, any one or more of a read-only memory (ROM), a programmable ROM (PROM), an erasable PROM (EPROM), an electrically erasable PROM (EEPROM), a random access memory (RAM), etc. may be used. In particular, the baggage tracking program (application or applet) and the like may be stored in the storage 130, and the stored information may be selected by the controller 140 as necessary.

When check-in information and baggage check-in (drop) information of the passenger are received, the controller 140 may generate the baggage data table of the passenger and store the generated baggage data table in the baggage database 126.

When baggage recognition information is received from the reader 21, the controller 140 may register the baggage recognition information in the baggage data table. In other words, when the baggage recognition information including reader identification information and baggage identification information is received from the reader 21, the controller 140 may record normal baggage recognition in the baggage data table corresponding to the baggage identification information and the reader identification information.

The controller 140 may determine whether the baggage has arrived at the destination through the baggage recognition information. When the baggage arrives at the destination, the controller 140 may transmit baggage location information to the terminal 40 of the passenger using the baggage data table. In this case, the controller 140 may detect the current location of the baggage using a baggage recognition record of the reader 21 recorded in the baggage data table and transmit the baggage location information including the time corresponding to the current location of the baggage, an estimated arrival time of the baggage, etc. to the terminal 40 of the passenger.

When there is the reader 21 that has not recognized the baggage in the baggage data table, the controller 140 may have the baggage searched for at the location of the reader 21 that has not recognized the baggage. When the baggage is not found, the controller 140 may transmit baggage delay notice information including the cause of a baggage delay to the terminal 40 of the passenger. In this case, the controller 140 may retrieve the nationality of the passenger through the baggage recognition information, translate the baggage location information or the baggage delay notice information into a language used by people of the nationality or a language registered in advance by the passenger, and transmit the translated baggage location information or baggage delay notice information.

When the baggage has not arrived at the destination, the controller 140 may transmit baggage misdelivery information including airport identification information and baggage information to the baggage management server 200. In this case, the controller 140 is required to have the misdelivered baggage delivered to the passenger. Accordingly, the controller 140 may search for the fastest flight that goes from the wrong airport (to where baggage is misdelivered) to the destination (destination airport) or a delivery address set by the passenger and transmit delivery schedule information of the misdelivered baggage including a retrieved flight and a scheduled arrival time of the flight to the terminal 40 of the passenger.

The controller 140 may retrieve information on the origin, the destination, the flight, etc. of the passenger in the passenger database 122 and determine whether the baggage of the passenger is moving along a correct destination route. When the baggage is moving away from the destination route, the controller 140 may transmit information indicating that the baggage has deviated from the destination route to the terminal 40 of the passenger.

Meanwhile, when the misdelivered baggage arrives at the destination airport with a delay, the passenger may not be in the destination airport. Accordingly, the controller 140 may receive information on a baggage delivery location from the passenger and have the baggage delivered to the delivery location. In this case, the controller 140 may provide baggage pickup locations (e.g., an airport terminal) in a corresponding area such that the passenger may personally select a delivery location among the pickup locations or input a delivery location (address).

FIG. 13 is a block diagram illustrating a baggage management server according to the exemplary embodiment of the present invention.

Referring to FIG. 13, the baggage management server 200 according to the exemplary embodiment of the present invention includes a communicator 210, an airport database 220, a storage 230, and a controller 240.

The communicator 210 communicates with the passenger terminal 40 or the airport management server 100 through a communication network.

The airport database 220 stores passenger information registered as origins according to airports, passenger information registered as destinations according to airports, etc. The passenger information may include names, terminal numbers, origins, destinations, flights, whether there is baggage, contents, etc. according to passengers.

The storage 230 is a component for storing data related to operations of the baggage management server 200. As the storage 230, a well-known storage medium may be used. For example, any one or more of a ROM, a PROM, an EPROM, an EEPROM, a RAM, etc. may be used. In particular, the baggage tracking program (application or applet) and the like may be stored in the storage 230, and the stored information may be selected by the controller 240 as necessary.

When baggage misdelivery information is received through the communicator 210, the controller 240 may transmit baggage misdelivery notice information including wrong airport (to where baggage is misdelivered) information to the terminal 40 of the passenger.

Also, after transmitting the baggage misdelivery notice information, the controller 240 may transmit baggage handling situation information at preset time intervals (e.g., 10 minutes to 30 minutes) to continuously notify the passenger of the baggage handling process. For example, the controller 240 may search for the fastest flight that goes from the wrong airport to the destination (destination airport) or a delivery address set by the passenger and transmit delivery schedule information of the misdelivered baggage including a retrieved flight and a scheduled arrival time of the flight to the terminal 40 of the passenger. When delivery address change information is received from the terminal 40 of the passenger, the controller 240 may transmit delivery notice information of the misdelivered baggage including the fastest flight going to the changed delivery address and a scheduled arrival time of the flight to the terminal 40 of the passenger. In this case, the controller 240 may transmit baggage handling situation information through a text message, a voice message, email, an SNS, etc.

In addition, the controller 240 may retrieve the nationality of the passenger from the airport database 220, translate the misdelivery notice information and the baggage handling situation information into a language used by people of the nationality or a language registered in advance by the passenger, and transmit the translated misdelivery notice information and baggage handling situation information.

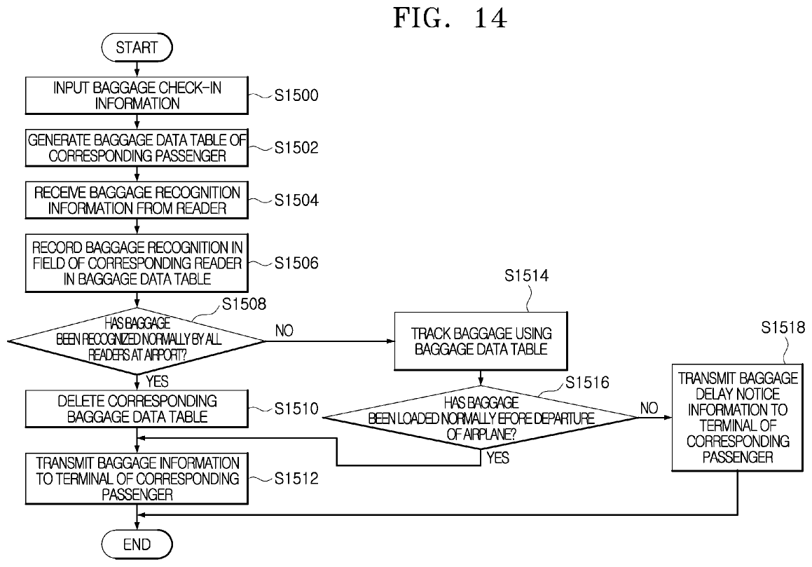

FIG. 14 is a flowchart illustrating a method of managing airport baggage according to the exemplary embodiment of the present invention.

Referring to FIG. 14, when check-in information of a passenger and baggage check-in (drop) information are input (S1500), the airport management server 100 generates a baggage data table of the passenger (S1502).

After operation S1502, when baggage recognition information is received from the reader 21 (S1504), the airport management server 100 records baggage recognition in a field of the reader 21 in the baggage data table (S1506). In this case, the airport management server 100 may record “0” in the field when the barcode of the baggage is recognized by the reader 21 normally and may record “X” in the field when the baggage is not recognized by the reader 21.

After operation S1506, when it is determined that the baggage has been recognized by all the readers 21 at the corresponding airport (S1508), the airport management server 100 deletes the baggage data table of the passenger corresponding to the airport (S1510) and transmits baggage information indicating that the baggage has been handled normally to the terminal 40 of the passenger (S1512).

When it is determined in operation S1508 that the baggage has not been recognized normally by all the readers 21 at the airport, the airport management server 100 tracks the baggage using the baggage data table (S1514).

After operation S1514, when the baggage is loaded onto a corresponding airplane on time (S1516), the airport management server 100 performs operation S1512.

When the baggage is not loaded onto the airplane on time (S1516), the airport management server 100 transmits baggage delay notice information to the terminal 40 of passenger (S1518).

According to the present invention, when baggage recognition information is received from a reader, normal baggage recognition is recorded in a baggage table corresponding to the baggage recognition information. Therefore, when there is baggage trouble, such as delayed baggage and lost baggage, it is possible to rapidly check whether there is baggage trouble and easily track the baggage involved in the trouble.

According to the present invention, information on baggage is provided through a text message. Therefore, it is possible to provide the service not only to customers who use a smartphone but also to customers who use a second generation (2G) phone, and the movement route and discharge gate of baggage and an estimated time for the baggage to arrive at the gate can be delivered in text. Consequently, users can conveniently drop off their baggage.

According to the present invention, a baggage information message to be displayed may be delivered in various languages, such as English, Chinese, and Japanese, and thus users of various languages can easily understand baggage information.

According to the present invention, rapid and accurate baggage information is provided to users, and thus it is possible to improve the service quality of airlines, provide a high-quality service in low-cost carriers, prevent theft, and provide a differentiated service from other airports.

According to the present invention, when a passenger arrives at a destination airport, he or she can immediately know that his or her baggage has been delivered incorrectly. For this reason, the misdelivered baggage can be rapidly and correctly handled, and thus it is possible to reduce the risk of losing the baggage.

According to the present invention, a passenger is notified of baggage misdelivery information in advance, that is, after arriving at the destination airport and before reporting the loss of baggage, and also the report process is facilitated.

According to the present invention, baggage location information, baggage delay notice information, baggage misdelivery notice information, etc. according to a baggage handling process are provided to a passenger, and thus the passenger can be aware of the location of his or her baggage in real time (or periodically). Also, the passenger can confirm the scheduled arrival time of his or her baggage and do something else in the meantime. In addition, the passenger can confirm that his or her baggage has been delivered to another airport through the baggage misdelivery notice information and rapidly take action accordingly such that the baggage can be prevented from being lost or stolen.

Although the present invention has been described above with reference to the exemplary embodiments shown in the drawings, the embodiments are merely illustrative, and those of ordinary skill in the art will appreciate that various modifications and equivalents can be made from the embodiments. Therefore, the technical scope of the present invention should be determined by the following claims.

What is claimed is:

1. A system for managing airport baggage, the system comprising:
an electronic tag attached to baggage of each passenger and storing baggage information;
a plurality of readers installed on one side of a conveyor, which automatically conveys the baggage to a gate and configured to recognize the electronic tag attached to the baggage passing therethrough; and
an airport management server installed at each airport and configured to generate, when baggage check-in information is input, a baggage data table of a corresponding passenger and record, when baggage recognition information including reader identification information and baggage identification information is received from the reader, normal baggage recognition in a baggage data table corresponding to the baggage recognition information.

2. The system of claim 1, wherein the airport management server generates a baggage data table with identification information of the readers provided in a baggage handling system, which will handle the baggage from a departure airport of the passenger to a destination airport, as a first axis and the baggage identification information of the passenger as a second axis.

3. The system of claim 1, wherein, when the baggage recognition information is received, the airport management server records normal baggage recognition in a field corresponding to the reader identification information of the baggage data table corresponding to the baggage recognition information and records no baggage recognition in a field corresponding to identification information of the reader from which the baggage recognition information is not received.

4. The system of claim 3, wherein, when the baggage is recognized normally by a certain number of consecutive readers, the airport management server deletes a baggage recognition record of the reader in front of the certain number of readers among baggage recognition records recorded in the baggage data table.

5. The system of claim 3, wherein, when the baggage is not recognized by a reader among the readers of the corresponding airport, the airport management server tracks the baggage using the baggage data table.

6. The system of claim 5, wherein, when the baggage is not loaded onto a corresponding airplane on time or is not found, the airport management server transmits baggage delay notice information to a terminal of the passenger.

7. The system of claim 1, further comprising a baggage management server connected to the airport management server installed at each airport through a communication network and configured to transmit baggage misdelivery notice information including wrong airport (to where baggage is misdelivered) identification information to a terminal of the passenger when baggage misdelivery information is received from the airport management server,
wherein, when the baggage does not arrive at a destination, the airport management server transmits the baggage misdelivery information including the airport identification information and the baggage information to the baggage management server.

8. The system of claim 7, wherein the airport management server or the baggage management server provides baggage handling situation information of at least one of check-in, transfer, and arrival of the baggage at the corresponding airport to the passenger and searches for, when the baggage is misdelivered, a fastest flight from the airport to the destination or a delivery address set by the passenger and transmits delivery schedule information of the misdelivered baggage including a retrieved flight and a scheduled arrival time of the flight to the terminal of the passenger.

9. A method of managing airport baggage, the method comprising:
when baggage check-in information is input, generating, by an airport management server, a baggage data table of a corresponding passenger; and
when baggage recognition information including reader identification information and baggage identification information is received from a reader, recording, by the airport management server, normal baggage recognition in the baggage data table corresponding to the baggage recognition information.

10. The method of claim 9, further comprising:
determining, by the airport management server, whether the baggage has arrived at a destination through the baggage recognition information;
when the baggage has not arrived at the destination, transmitting, by the airport management server, baggage misdelivery notice information including wrong airport (to where baggage is misdelivered) identification information to a terminal of the corresponding passenger and transmitting baggage misdelivery information including the airport identification information and baggage information to a baggage management server; and
transmitting, by the baggage management server, information on a situation of handling the baggage to the terminal of the passenger.
